(19) United States
(12) Patent Application Publication
(10) Pub. No.: US 2016/0037176 A1
(43) Pub. Date: Feb. 4, 2016

(54) AUTOMATIC AND ADAPTIVE SELECTION OF PROFILES FOR ADAPTIVE BIT RATE STREAMING

(71) Applicant: ARRIS Enterprises, Inc., Suwanee, GA (US)

(72) Inventor: Santhana Chari, Johns Creek, GA (US)

(21) Appl. No.: 14/446,767

(22) Filed: Jul. 30, 2014

(51) Int. Cl. H04N 19/40; H04L 29/06

(52) U.S. Cl. CPC H04N 19/40; H04L 65/601; H04L 65/607

(57) ABSTRACT

Disclosed are methods and systems for a transcoding device to provide sets of video streams or profiles having different encoding parameters for transmitting the sets of video streams to a media device. In an embodiment, a method for transmitting video streams for a media program from a transcoding device to a media device includes receiving, by the transcoding device, video data; generating, by the transcoding device, a plurality of profiles from the video data, each profile representing a video stream; performing analysis on the generated plurality of profiles to identify similar profiles; reducing the number of profiles to provide a distinct set of profiles; and transmitting the distinct set of profiles from the transcoding device to the media device.

### TECHNICAL FIELD

The present disclosure is related generally to adaptive bit rate streaming and, more particularly, to the generation of reduced sets of video streams for use in adaptive bit rate streaming.

### BACKGROUND

Multimedia streaming over a network from a content server to a media device has been widely adopted for media consumption. One type of media streaming, adaptive bit rate (ABR) streaming is a technique used to stream media over computer networks. Current adaptive streaming technologies are almost exclusively based on HTTP and designed to work efficiently over large distributed HTTP networks such as the Internet.

For example, HTTP live streaming (HLS) protocol allows a content server to publish variant playlist files to media devices. A variant playlist file identifies multiple sets video streams or profiles for a media program, such as a movie, a television program, etc. where each set of video streams or profiles has unique encoding parameters (e.g., bit rates, resolutions, etc.) for the media program. As used herein, each stream at a particular resolution or bit rate is called a profile.

The media devices may dynamically switch between the profiles identified in the variant playlist file as the sets of video streams are transmitted from the content server to the media devices. The media devices may choose to receive an initial set of video streams identified in the variant playlist file based on initial network conditions, initial buffer conditions, etc. For example, the media devices may choose to receive high definition (HD) video streams identified in the variant playlist file if the initial network conditions, the initial buffer conditions, etc. support the streaming of the HD video streams. If the network conditions degrade or if the buffer conditions degrade, etc., then the media devices may choose to receive a lower definition or lower bitrate video streams identified in the variant playlist file. That is, the media device may choose different video streams to receive from the content server where the different sets of video streams have different encoding parameters.

Selection and transmission of the video streams are driven by the media devices. In response to a selection of a video streams identified in the variant playlist file, the content server passively transmits the video streams to the media device. While a media device may select the profiles it receives dynamically, the sets of video streams or profiles provided to the content server by a transcoder and then to the media devices are typically static or fixed. Consequently, the content server will typically receive and store numerous profiles for the media devices to select from. This generation and storage of numerous profiles is computationally and storage intensive.

### SUMMARY OF THE EMBODIMENTS

Described herein are techniques and systems for a transcoding device to provide sets of video streams or profiles having different encoding parameters for transmitting the sets of video streams to a media device. The resultant profiles are distinct and may meet specified minimum thresholds.

In a first aspect, a method for transmitting video streams for a media program from a transcoding device to a media device is disclosed. The method includes receiving, by the transcoding device, video data; generating, by the transcoding device, a plurality of profiles from the video data, each profile representing a video stream; performing analysis on the generated plurality of profiles to identify similar profiles; reducing the number of profiles to provide a distinct set of profiles; and transmitting the distinct set of profiles from the transcoding device to the media device. In an embodiment of the first aspect, the similar profiles include a similar bit rate or spatial resolution. In an embodiment of the first aspect, a first profile is similar to a second profile if the bit rate for the first profile is within a range of 10% of the second profile. In an embodiment of the first aspect, a first profile is similar to a second profile if the spatial resolution for the first profile is within a range of 10% of the second profile. In an embodiment of the first aspect, the method further includes receiving a minimum threshold profile requirement; and transmitting the distinct set of profiles from the transcoding device to the media device that meet or exceed the minimum threshold requirement. In an embodiment of the first aspect, the minimum threshold requirement is indicative of video quality.

In a second aspect, a method for transmitting video streams for a media program from a transcoding device to a media device is disclosed. The method includes receiving, by the transcoding device, video data; performing analysis on the video data based in part on the spatial and/or temporal complexity in the video data to determine profile requirements; generating, by the transcoding device, a plurality of profiles from the video data, each profile representing a video stream, wherein the generated profiles meet or exceed the determined profile requirements; and transmitting the plurality of profiles from the transcoding device to the media device. In an embodiment of the second aspect, spatial activity is determined by analyzing video frames to identify high textured areas and flat textured areas. In an embodiment of the second aspect, temporal activity is determined by performing pixel accurate motion estimation between video frames. In an embodiment of the second aspect, the determined profile requirements are indicative of video quality. In an embodiment of the second aspect, the determined profile requirements include a minimum and maximum value of spatial resolution and bit rate that provide boundaries for the generated profiles.

In a third aspect, a method for transmitting video streams for a media program from a transcoding device to a media device is disclosed. The method includes receiving, by the transcoding device, video data; generating, by the transcoding device, a plurality of profiles from the video data, each profile representing a video stream; providing metadata indicative of video quality to each of the plurality of profiles; transmitting the plurality of profiles from the transcoding device to the media device; and selecting, by the media device, one or more profiles based on the metadata. In an embodiment of the third aspect, the media device includes a device selected from the group consisting of: a transcoder, a packager, a server, a caching server, and a home gateway. In an embodiment of the third aspect, the video quality is provided in the form of a video quality score. In an embodiment of the third aspect, the video quality score is an absolute value that serves as a proxy for a minimum threshold.

In a fourth aspect, a transcoding device for transmitting a set of video streams to a media device is disclosed. The transcoding device includes a set of processors; and a computer-readable storage medium comprising instructions for controlling the set of processors to be configured for: receiving video data; generating a plurality of profiles from the video data, each profile representing a video stream; performing analysis on the generated plurality of profiles to identify similar profiles; reducing the number of profiles to provide a distinct set of profiles; and transmitting the distinct set of profiles from the transcoding device to the media device.

In a fifth aspect, a transcoding device for transmitting a set of video streams to a media device is disclosed. The transcoding device includes a set of processors; and a computer-readable storage medium comprising instructions for controlling the set of processors to be configured for: receiving video data; performing analysis on the video data based in part on the spatial and/or temporal complexity in the video data to determine profile requirements; generating a plurality of profiles from the video data, each profile representing a video stream, wherein the generated profiles meet or exceed the determined profile requirements; and transmitting the plurality of profiles from the transcoding device to the media device.

In a sixth aspect, a transcoding device for transmitting a set of video streams to a media device is disclosed. The transcoding device includes a set of processors; and a computer-readable storage medium comprising instructions for controlling the set of processors to be configured for: receiving video data; generating a plurality of profiles from the video data, each profile representing a video stream; providing metadata indicative of video quality to each of the plurality of profiles; and transmitting the plurality of profiles from the transcoding device to the media device. In an embodiment of the sixth aspect, the media device is configured to select one or more profiles based on the metadata. In an embodiment of the sixth aspect, the media device is configured to receive said selected profiles from the transcoder device.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of some of the devices of FIG. 2;

FIG. 2 is an overview of a representative environment in which the present techniques may be practiced;

FIG. 3 is an example profile list;

FIG. 4 is an example graph showing the variation in video quality for a single profile provided in FIG. 3;

FIG. 5 is an example graph showing the variation in video quality for some of the profiles having the same content provided in FIG. 3;

FIG. 6 is a flowchart of a representative method for reducing the number of profiles in a profile list;

FIG. 7 is a flowchart of a representative method for reducing the number of profiles in a profile list; and

FIG. 8 is a flowchart of a representative method for providing smart profiles in a profile list.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

ABR transcoding or encoding is prevalently used for delivering video over IP networks. In ABR transcoding, a single piece of input content (e.g., a HD movie) is ingested by a transcoding device. The ingested video is transcoded into multiple output streams each at different resolutions or bit rates or both. As previously provided, each stream at a particular resolution or bit rate is called a profile.

A problem in ABR delivery is the selection of number of profiles, and the resolution and bit rate associated with each profile. Current techniques hand-pick the profiles, meaning that the profiles are manually selected by a designer or architect. Typically the profiles include resolutions starting at HD (1080i30 or 720p60) and going all the down to small mobile resolutions such as 312×180 pixels. Bit rates associated with each profile are also hand-picked based on the designers' assumptions on specific bit rates that will be adequate to encode the individual profiles at an acceptable quality.

A limitation in the above method is the static selection of profiles. Video content is highly diverse and the encoding complexity (e.g., number of bits required to encode the content at a given quality) can vary drastically between different media assets. For example, a media asset that contains a sports scene with multiple players and crowd background will require more encoding bits to produce a certain video quality compared to a “head and shoulder” scene of a news anchor sitting at a desk. Even within a given media asset, the content characteristics can vary widely over time making the static selection of profiles sub-optimal.

Described herein is an automatic and dynamic method of selecting profiles. In accordance with some embodiments, a video processing device (e.g., encoder or transcoder) that ingests input content performs analysis on the video content to generate information on the encoding complexity of the video content.

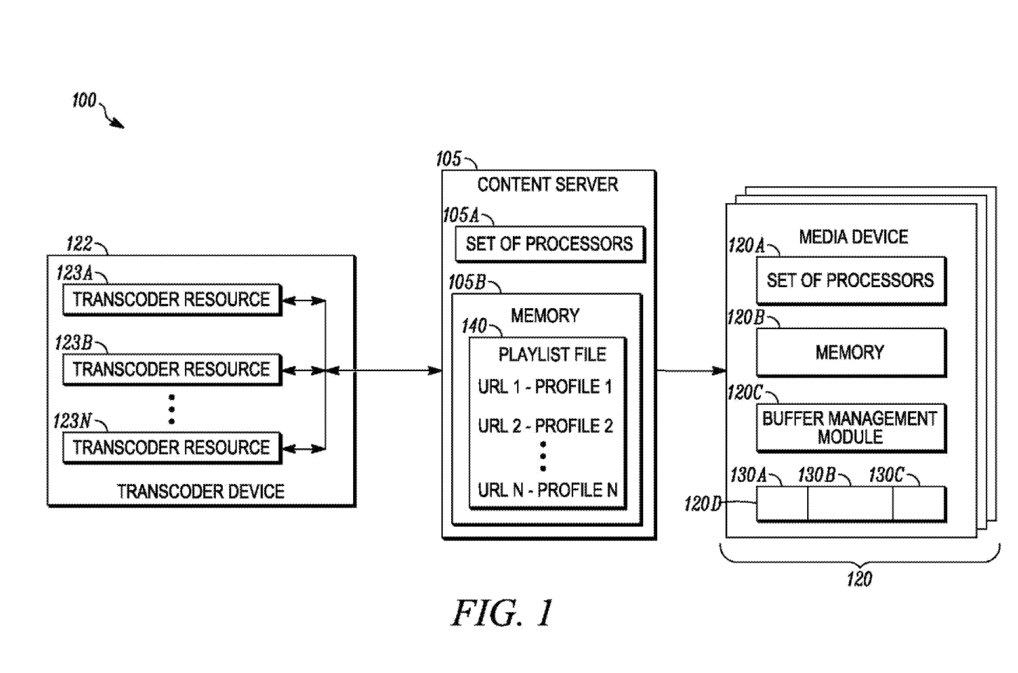

FIG. 1 depicts a simplified video streaming system 100 according to one embodiment. Video streaming system 100 includes a content delivery network (CDN) or content server 105, a set of media devices 120, and a transcoder device 122. CDN 105 may transmit sets of video streams to media devices 120 via connection or network 115. A set of video streams may be for a media program, such as a movie, a television program etc. Each video stream in a set of video streams, also referred to as a profile, may be a short segment of video (e.g., two seconds, ten seconds, etc.). A set of video streams or profiles may include thousands of video streams for a media program, such as a two hour movie. The sets of video streams may be provided to CDN 105 from transcoder device 122. Transcoder device 122 may include a number of transcoder resources 123 where each transcoder resource 123 may provide a set of video streams having unique encoding parameters (e.g., a bit rate, a resolution, etc.). Network 115 may include the Internet, various intranets, etc. Network 115 may include wired links and wireless links. It will be understood that the various references made herein to “media” and “video” include both video content and audio content.

As used herein, a video program or asset refers generally to a movie or television program. For ABR delivery, each video program asset is transcoded into multiple profiles. As used herein, a profile is an instance of the asset encoded at a particular resolution and bitrate. Each profile is divided into chunks or segments (e.g., two seconds, ten seconds, etc.) for delivery to the client devices.

CDN 105 may include a set of processors 105a and a non-transitory computer readable storage medium (memory) 105b. Memory 105b may store instructions, which the set of processors 105a may execute to carry out various embodiments described herein. CDN 105 may include a number of computer devices that share a domain. Each media device 120 may include a set of processors 120a and a non-transitory computer readable storage medium (memory) 120b. Memory 120b may store instructions, which the set of processors 120a may execute to carry out various embodiments described herein.

Media device 120 may also include a buffer management module 120c and a receive buffer 120d. Receive buffer 120d receives video packets for a set of video streams that is transmitted from CDN 105 to media device 120 for a media program. The video packets may be retrieved by the set of processors 120a from receiver buffer 120d as media device 120 consumes the video packets. As used herein, encoded content such as video packets may be divided into fixed duration segments (e.g., chunks). The segments or chunks are typically between two and 10 seconds in duration, although they may be longer or shorter. Each second can have 30 or 60 frames. In some embodiments, shorter segments reduce coding efficiency while larger segments impact speed to adapt to changes in network throughput.

In some embodiments, receive buffer 120d includes three buffer sections 130a, 130b, and 130c. First buffer section 130a may be for video packets that media device 120 has received from content server 105 but has not consumed for media play. Media device 120 may have acknowledged receipt of the video packets in first buffer section 130a to CDN 105 via an acknowledgment. Buffer management module 120c may monitor the rate at which video packets in first buffer section 130a are retrieved for consumption by media device 120.

Second buffer section 130b may be for video packets that media device 120 has received from CDN 105 but has not consumed for media play. Media device 120 may not have sent acknowledgments to CDN 105 for the video packets in second buffer section 130b. Portions of second buffer section 130b may be categorized as portion of first buffer section 130a as acknowledgments for video packets in second buffer section 130b are transmitted to content server 105 from media device 120. Buffer management module 120c may track the portions of second buffer section 130b that are categorized as a portion of first video buffer 130a when media device 120 sends an acknowledgment to CDN 105 for acknowledging receipt of the video packets in second buffer section 130b.

Third buffer section 130c may be available for receipt of video packets. Buffer management module 120c may monitor third buffer section 130c to determine when third buffer section 130c receives video packets and is categorized as a portion of second buffer section 130b. Portions of first buffer section 130a may be categorized as a portion of third buffer section 130c as video packets from first buffer section 130a are consumed. That is, the portion of first buffer section 130a for which video packets are consumed, may receive new video packets from CDN 105.

The sizes of first, second, and third buffer sections 130a-130c together define the maximum buffer size for video packet buffering according to some embodiments. The maximum buffer size may be allocated by media device 120 when opening an initial connection with content server 105. The maximum buffer size typically remains unchanged after the allocation.

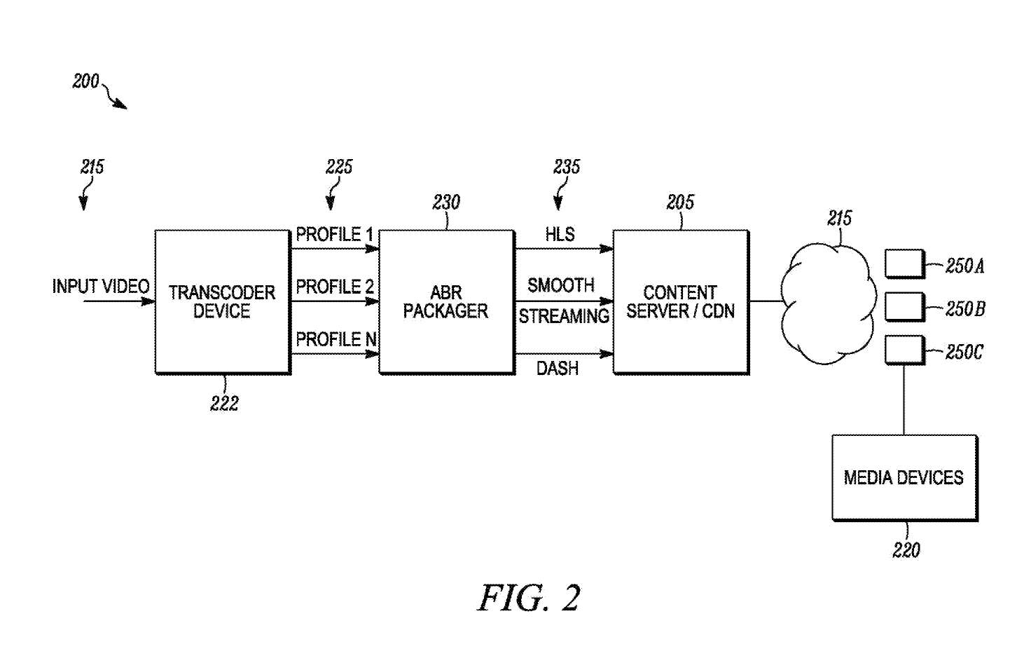

FIG. 2 depicts an overview of a representative environment in which the present techniques may be practiced. Video streaming system 200 includes a transcoder device 222, ABR packager 230, content server or CDN 205, network 215, edge cache servers 250a, 250b, 250c and a set of media devices 220. Transcoder device 222, CDN 205 and media devices 220 may operate as described above with reference to FIG. 1's respective components. While not expressly shown, the components in video streaming system 200 include components necessary to function and known by those of skill in the art. For example, transcoder device 222 may include a receive buffer for receiving video content stream 215, as described below.

In some embodiments, transcoder device 222 is configured to receive video content in video content stream 215 from a content/program provider (not shown) over any number of possible distribution networks with the goal of delivering this content to subscriber media devices 220 as an ABR streaming service. As used herein, transcoder device may refer to any device that encodes content into an acceptable format for ABR streaming. Video content stream 215 may be uncompressed video or compressed video (e.g., MPEG-2, H.264 or MPEG-4, AVC/H.264, HEVC/H.265, etc.) according to current standards.

As described above, ABR streaming is a technology that works by breaking the overall media stream into a sequence of small HTTP-based file downloads, each download loading one short segment of an overall potentially unbounded transport stream. As the stream is played, the client (e.g., media device 220) may select from a number of different alternate profiles containing the same material encoded at a variety of bit rates, allowing the streaming session to adapt to the available bit rate. At the start of the streaming session, the player downloads/receives a manifest containing the metadata for the various sub-streams which are available. Since its requests use only standard HTTP transactions, ABR streaming is capable of traversing a firewall or proxy server that lets through standard HTTP traffic, unlike protocols such as RTP. This also allows a CDN to readily be implemented for any given stream. ABR streaming methods have been implemented in proprietary formats including HTTP Live Streaming (HLS) by Apple, Inc and HTTP Smooth Streaming by Microsoft, Inc. ABR streaming has been standardized as ISO/IEC 23009-1, Information Technology—Dynamic adaptive streaming over HTTP (DASH): Part 1: Media presentation description and segment formats.

In some embodiments, ABR Packager 230 is responsible for communicating with each client and preparing (“packaging”) individual ABR streams in real-time, as requested by each client or media device 220. The ABR Packager 230 may be configured to retrieve client-specified profiles from transcoder device 222 and translate them into the appropriate ABR format on a per-client/session basis. As shown, ABR Packager 230 can translate profiles into various format streams 235 including HLS, smooth streaming, and DASH, among others.

ABR Packager 230 communicates with and delivers content to each client or media device 220 via CDN 205. In some embodiments, each client or media device 220 is an ABR player. For example, a particular client 220 may be instructed to obtain specific content (e.g., an On-Demand movie or recorded broadcast program) from the ABR Packager 230. The ABR Packager 230 then passes the requested content on to media device 220.

As shown, system 200 includes a plurality of edge cache servers 250a, 250b, 250c. Edge cache servers 250 are servers that are located at the edge of the network closer to the client devices 220. Edge cache servers 250 allow CDN 205 to scale delivery to a large number of clients by storing the content closer to the edge of the network and directly serving content to the client devices 220.

In some embodiments, the encoded content may include program events (e.g., commercials) or additional information related to the content of the video stream(s) which may be signaled using a protocol such as SCTE-35 (e.g., as metadata). Any suitable device (e.g., content/program provider (not shown), transcoder device 222, ABR packager 230) may provide the event signaling. For example, the metadata may be passed by transcoder device 222 to ABR Packager 230. Thereafter, ABR Packager 230 may include the appropriate information as provided by the metadata.

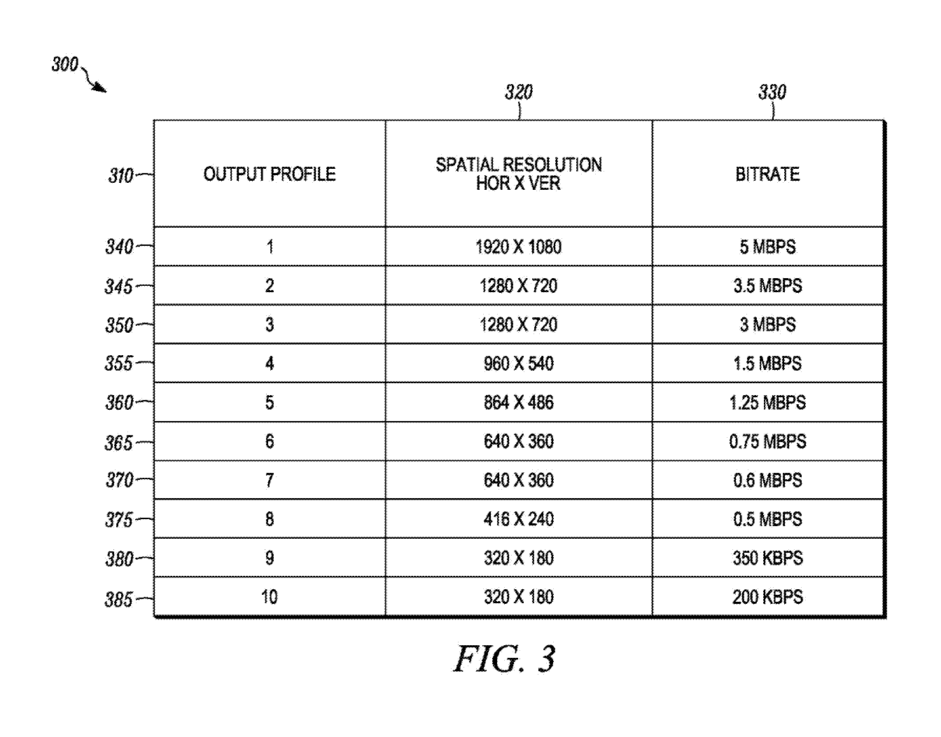

FIG. 3 is an example profile list 300 used in a typical service delivery. In some embodiments, example profile list 300 is selected by a designer. Thereafter, transcoder device 222 is configured to generate the static list of profiles.

As shown, profile list 300 includes an output profile number 310, spatial resolution 320 and bit rate 330. Within profile list 300 are exemplary output profiles 340, 345, 350, 355, 360, 365, 370, 375, 380, 385, each being assigned an output profile number 310, spatial resolution 320 and bit rate 330. From reviewing FIG. 3, output profile #2 345 and output profile #3 350 appear to have at least similar spatial resolutions 320 and bit rates 330, output profile #6 365 and output profile #7 370 appear to have at least similar spatial resolutions 320 and bit rates 330, and output profile #9 380 and output profile #10 385 appear to have at least similar spatial resolutions 320 and bit rates 330. For example, output profile #2 345 and output profile #3 350 have the same spatial resolution 320 and only differ in bit rate 330 by 0.5 mbps; output profile #6 365 and output profile #7 370 have the same spatial resolution 320 and only differ in bit rate 330 by 0.15 mbps; and output profile #9 380 and output profile #10 385 have the same spatial resolution 320 only differ in bit rate 330 by 150 kbps.

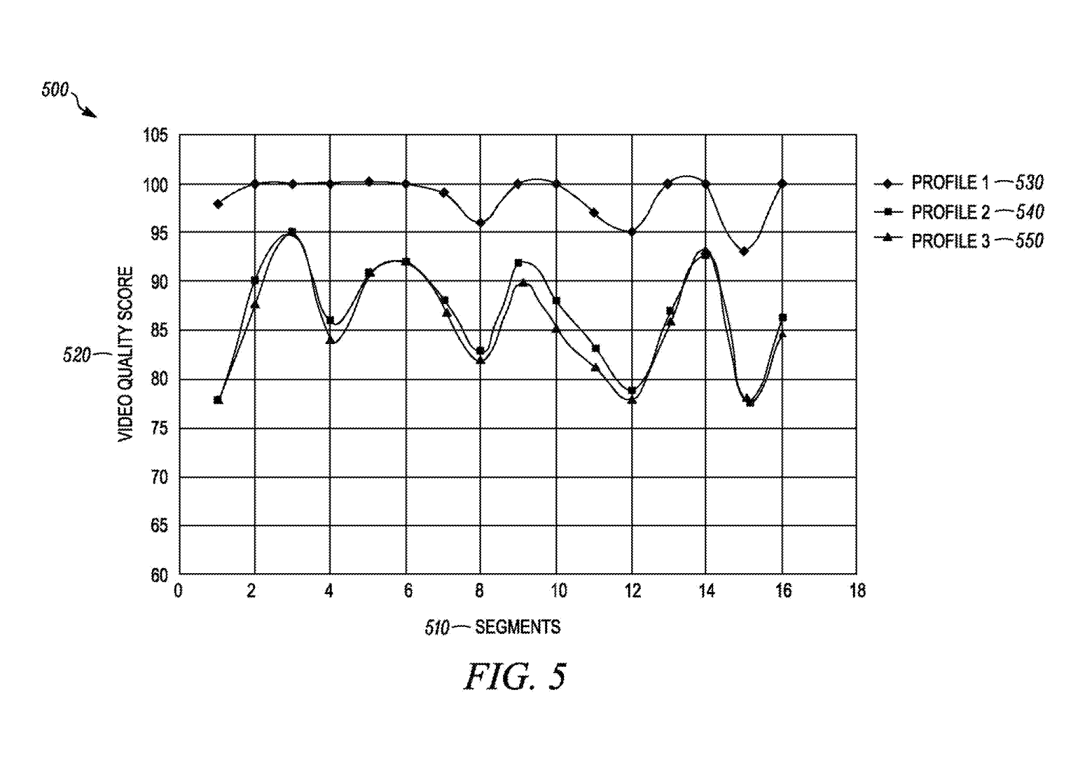

From reviewing the profile list 300, one or more of the output profiles 340- 385 may appear redundant or duplicative; these being the most similarly performing. Thus, for most instances, only one of output profile #2 345 and output profile #3 350 can be generated and/or transmitted, only one of output profile #6 365 and output profile #7 370 can be generated and/or transmitted, and only one of output profile #9 380 and output profile #10 385 can be generated and/or transmitted. It should be noted that the reduction is adaptive to the content. For example, for a given piece of content, profiles #2 345 and #3 350 may still exhibit difference in quality, but for other pieces of content they may not. In such embodiments, the reduction is done not by looking at the profile list 300, but by looking at the quality (or the expected quality) during the transcoding process. In some embodiments, the number of output profiles in output profile list 300 may be reduced from 10 to 7. This will become more apparent in the discussion of FIG. 5.

The reduction of output profiles in desirable because reducing the number of profiles reduces the storage requirement in the CDN 205 (e.g., in origin and edge cache servers). In some embodiments, the characteristics of the profiles are modified adaptive to the content so that the video quality (or the Quality of Experience) resulting from different profiles are not exactly the same.

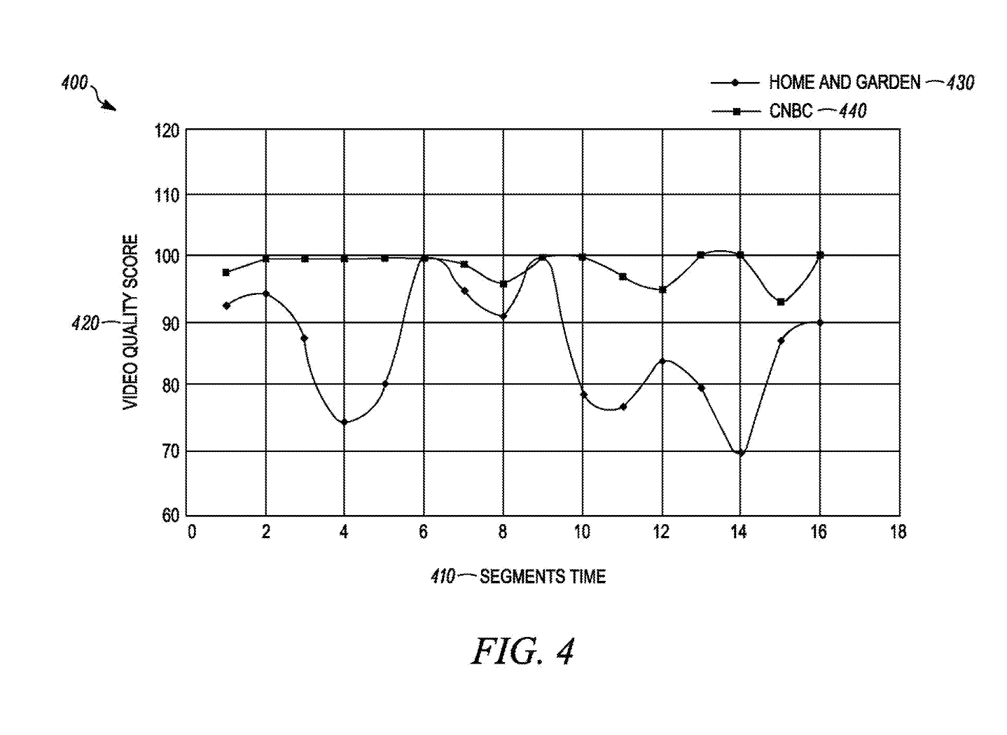

FIG. 4 is an example graph 400 showing the variation in video quality for a single profile provided in FIG. 3. Graph 400 includes a plurality of video segments 430 and 440 plotted according to video quality score 420 and segment time or duration 410. Video quality score 420 is provided as an absolute number and not in percentage form. Segment time or duration 410 is provided in the range of about 10 seconds or less for each segment. As shown, video segment 430 is for a home and garden television channel and video segment 440 is for a news channel such as CNBC. Such differences in channel content are known to require different resources. For example, spatial complexity and temporal complexity can vary greatly depending on content type. Programs with different complexity require different bitrates to achieve a visually pleasing video quality.

From reviewing graph 400, it is clear that video segment 440 maintains a consistent quality score 420 of about 100 over the provided segment time 410. In contrast, video segment 430 varies in quality score 420 from about 70 to 100 over the provided segment time 410. What should be realized is that both video segments 430 and 440 are shown for a single selected profile; thus depending on content type, the selected profile may or may not be a good fit. However, if a minimum threshold for the video quality score 420 is met for each of video segments 430 and 440, the selected profile may be adequate even if it is not a good fit.

As provided above, the video quality can vary a lot in the hand selection process. With static selection of profiles, a bitrate and resolution combination is selected. As the complexity in the video quality changes, this results in changes in video quality of the encoded stream. Thus, determining a minimum threshold for the particular content and then selecting a profile to achieve the threshold is desirable. In some embodiments, selecting a profile that will operate at or slightly above a threshold is desirable.

FIG. 5 is an example graph 500 showing the variation in video quality for some of the profiles having the same content. Graph 500 includes a video segment according to different video profiles; output profile #1 340 is plotted as video segment 530, output profile #2 345 is plotted as video segment 540, and output profile #3 350 is plotted as video segment 550. Similar to FIG. 4, the video segments 530, 540, 550 are plotted according to video quality score 520 and segment time or duration 510. Video quality score 520 is provided as an absolute number and not in percentage form. Segment time or duration 510 is provided in the range of about 10 seconds or less for each segment.

From reviewing graph 500, it is clear that video segment 540 (provided by profile #2 345) and video segment 550 (provided by profile #3 350) appear duplicative or redundant. Consequently, one of profile #2 345 or profile #3 350 may be reduced. The reduction of output profiles in desirable because reducing the number of profiles reduces the storage requirement in the CDN 205.

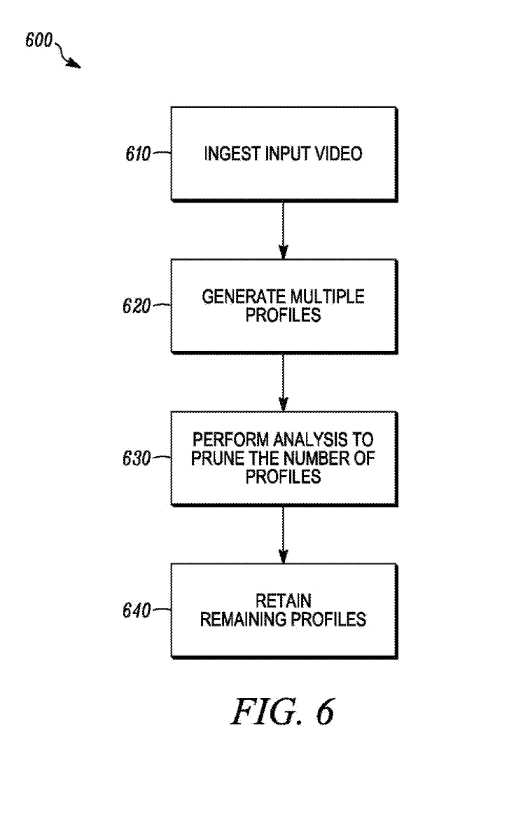

FIG. 6 is a flowchart of a representative method 600 for reducing the number of profiles in a profile list for live or streaming video. In a first step 610, input video is received by or ingested by a system, such as system 200. In some embodiments, a transcoder device such as transcoder device 122 or 222 receives the input video. In a second step 620, the system generates multiple profiles, such as shown in FIG. 3. In a next step 630, the system performs an analysis to prune redundant profiles, such as described in FIGS. 3 and 5. In step 640, the system transmits the remaining, distinct output profiles. As used herein, “distinct” refers to output profiles that do not substantially duplicate other output profiles. In some embodiments, redundant profiles are profiles that exhibit more than 90% similarity.

In some embodiments, the result of method 600 is that the number of profiles produced is reduced. Furthermore, the profiles produced are dynamic in that they are adaptive to video content. For example, the profile selection can be performed to meet a quality target (e.g., based on video quality score, etc.) rather than a hard-coded profile resolution or bit rate. In some embodiments, minimum and/or maximum values of profile resolution and/or bit rates may be used as boundaries for the dynamic range of the parameters of the profiles. The dynamic profile selection of method 600 can be performed by any suitable component including a transcoder, packager, or software running on a server (e.g., CDN).

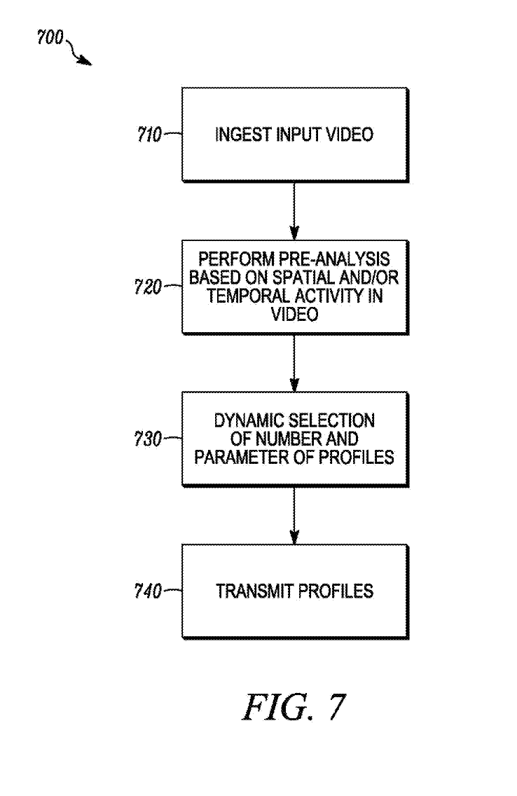

FIG. 7 is a flowchart of a representative method 700 for reducing the number of profiles in a profile list for live or streaming video. In a first step 710, input video is received by or ingested by a system, such as system 200. In second step 720, the system performs a pre-analysis of the video content. For example, the transcoder device may include a receive buffer in which a predefined or predetermined number of video frames is buffered and content analysis is performed on the buffered video. This receive buffer may be similar to receive buffer 120d in media device 120 of FIG. 1. In some embodiments, the number of video frames buffered is chosen based on the permissible delay in the system as well as how frequently the profile information can be modified.

Alternatively, in some embodiments, content analysis performed on the current set of video frames is used to predict the profile selection of the video frames that are ingested in the near future. In such embodiments, an assumption that the analysis performed in the past set of frames is a good predictor of the encoding complexity of the frames about to be transcoded may be used.

Content analysis to estimate the encoding complexity can be performed in many different ways such as estimating spatial complexity, temporal complexity, and combinations of spatial and temporal complexity. For example, spatial complexity can be estimated by analyzing individual video frames to identify high textured areas vs. “flat” areas. Textured areas require more bits to encode compared to smooth areas, thus resulting in different encoding complexity.

Temporal complexity can be estimated by performing pixel accurate motion estimation between frames. Standards-based video encoders use sub-pixel accurate motion estimation, but highly accurate encoding complexity can be generated by simpler pixel accurate motion estimation. As is known, motion estimation between blocks in two different pictures can be performed with different levels of pixel accuracy. Video compression standards allow motion estimation at sub-pixel (half pixel, quarter pixel) accuracy. However the complexity of motion estimation increases from integer to half to quarter pel accuracy. Temporal complexity can be estimated with pixel accurate motion estimation.

A combination of temporal and spatial complexity can also be used to determine the encoding complexity of the video. For example, spatial and temporal complexity can be added with equal weights in some cases and with different weights in other cases.

Still referring to FIG. 7, in step 730, based on the content analysis, a dynamic set of profiles are selected and this selection is used to transcode the input video to multiple output profiles. In step 740, the system transmits the output profiles. In some embodiments, the result of method 700 is that the system has a reduced computational requirement due to a smaller number of profiles being transcoded.

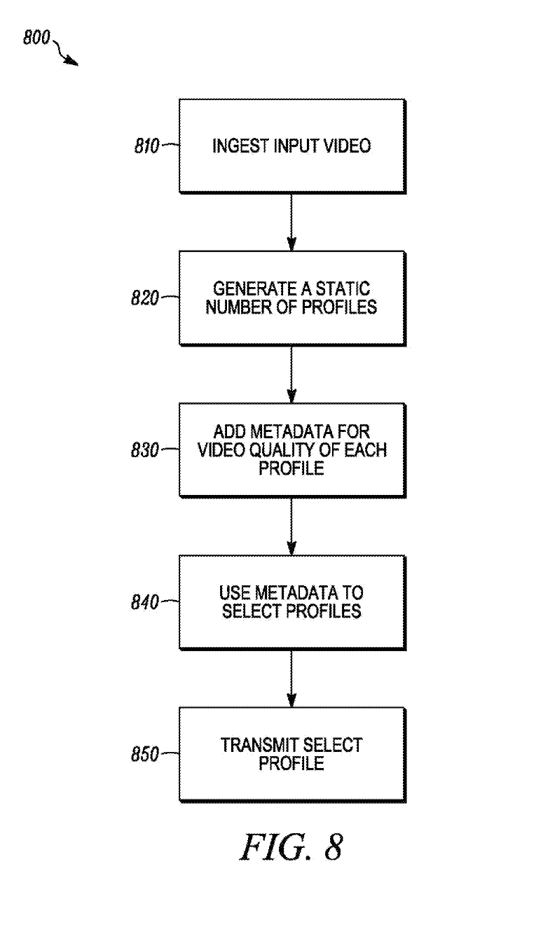

FIG. 8 is a flowchart of a representative method 800 for providing smart profiles in a profile list for off-line transcoding for video on demand (VoD) type of applications. In such embodiments, a whole media asset or file can be processed. In a first step 810, input video is received by or ingested by a system, such as system 200. In a second step 820, the system generates a static number of profiles. Thereafter, in step 830, the system adds, provides, and/or inserts metadata related to video quality of each profile in the video stream where the meta data is supported. In some embodiments, the meta data is a set of intermediate statistics like the number of bits used to encode a frame, average size of a quantizer, etc. that can be used downstream to derive a measure of video quality. In some embodiments, the transcoder generates and inserts the meta data into the video stream.

At step 840, the system uses the metadata and/or content analysis of the media file to select the output profiles. Here again, a single set of output profiles can be chosen for the whole asset or multiple set of profiles can be used to adapt to the variations of the video content in a single file. In some embodiments, the profile selection step 840 can be performed prior to storage or during stream delivery to client devices. At step 850, the selected profiles are transmitted.

While the methods of FIGS. 6-8 generally describe content analysis and profile selection being performed by a single component or piece of equipment within the system, any number of components may be used to effectuate the methods. In some embodiments, the content analysis and the profile selection can be done in two different devices. For example, the transcoder in a cable head-end (or cloud) can perform the content analysis and generate the required information which can be embedded as user-data in an MPEG bit stream. A transcoder in home media gateway can use the content analysis information to select the profiles dynamically based on the content characteristics as well as network characteristics inside the home. An approach like this reduces the amount of computationally intensive video analysis that is normally performed in a home gateway device, and instead pushes the video analysis into the head-end device.

In view of the many possible embodiments to which the principles of the present discussion may be applied, it should be recognized that the embodiments described herein with respect to the drawing figures are meant to be illustrative only and should not be taken as limiting the scope of the claims. For example, while FIGS. 1 and 2 illustrate media devices 120 and 220 being the recipients of the generated profiles, the output of the transcoder can go directly to a media device or to a downstream delivery device, such as a packager or a server that streams the data over an IP network. Therefore, the techniques as described herein contemplate all such embodiments as may come within the scope of the following claims and equivalents thereof.

We claim:

1. A method for transmitting video streams for a media program from a transcoding device to a media device, the method comprising:
receiving, by the transcoding device, video data;
generating, by the transcoding device, a plurality of profiles from the video data, each profile representing a video stream;
performing analysis on the generated plurality of profiles to identify similar profiles;
reducing the number of profiles to provide a distinct set of profiles;
transmitting the distinct set of profiles from the transcoding device to the media device.

2. The method of claim 1, wherein a measure of video quality is used to identify the similarity of the profiles.

3. The method of claim 2, wherein a first profile is similar to a second profile if the measured or estimated video quality for the first profile is within a range of 10% of the second profile.

4. The method of claim 1, wherein the similar profiles include a similar bit rate or spatial resolution.

5. The method of claim 4, wherein a first profile is similar to a second profile if the bit rate for the first profile is within a range of 10% of the second profile.

6. The method of claim 4, wherein a first profile is similar to a second profile if the spatial resolution for the first profile is within a range of 10% of the second profile.

7. The method of claim 1, further comprising:
receiving a minimum threshold profile requirement; and
transmitting the distinct set of profiles from the transcoding device to the media device that meet or exceed the minimum threshold requirement.

8. The method of claim 7, wherein the minimum threshold requirement is indicative of video quality.

9. A method for transmitting video streams for a media program from a transcoding device to a media device, the method comprising:
receiving, by the transcoding device, video data;
performing analysis on the video data based in part on the spatial and/or temporal complexity in the video data to determine profile requirements;
generating, by the transcoding device, a plurality of profiles from the video data, each profile representing a video stream, wherein the generated profiles meet or exceed the determined profile requirements;
transmitting the plurality of profiles from the transcoding device to the media device.

10. The method of claim 9, wherein spatial activity is determined by analyzing video frames to identify high textured areas and flat textured areas.

11. The method of claim 9, wherein temporal activity is determined by performing pixel accurate motion estimation between video frames.

12. The method of claim 9, wherein the determined profile requirements are indicative of video quality.

13. The method of claim 12, wherein the determined profile requirements include a minimum and maximum value of spatial resolution and bit rate that provide boundaries for the generated profiles.

14. A method for transmitting video streams for a media program from a transcoding device to a media device, the method comprising:
receiving, by the transcoding device, video data;
generating, by the transcoding device, a plurality of profiles from the video data, each profile representing a video stream;
providing metadata indicative of video quality to each of the plurality of profiles;
transmitting the plurality of profiles from the transcoding device to the media device;
selecting, by the media device, one or more profiles based on the metadata.

15. The method of claim 14, wherein the media device comprises a device selected from the group consisting of: a transcoder, a packager, a server, a caching server, and a home gateway.

16. The method of claim 14, wherein the video quality is provided in the form of a video quality score.

17. The method of claim 16, wherein the video quality score is an absolute value that serves as a proxy for a minimum threshold.

18. A transcoding device for transmitting a set of video streams to a media device comprising:
a set of processors; and
a computer-readable storage medium comprising instructions for controlling the set of processors to be configured for:
receiving video data;
generating a plurality of profiles from the video data, each profile representing a video stream;
performing analysis on the generated plurality of profiles to identify similar profiles;
reducing the number of profiles to provide a distinct set of profiles;
transmitting the distinct set of profiles from the transcoding device to the media device.

19. A transcoding device for transmitting a set of video streams to a media device comprising:
a set of processors; and
a computer-readable storage medium comprising instructions for controlling the set of processors to be configured for:
receiving video data;
performing analysis on the video data based in part on the spatial and/or temporal complexity in the video data to determine profile requirements;
generating a plurality of profiles from the video data, each profile representing a video stream, wherein the generated profiles meet or exceed the determined profile requirements;
transmitting the plurality of profiles from the transcoding device to the media device.

20. A transcoding device for transmitting a set of video streams to a media device comprising:
a set of processors; and
a computer-readable storage medium comprising instructions for controlling the set of processors to be configured for:
receiving video data;
generating a plurality of profiles from the video data, each profile representing a video stream;
providing metadata indicative of video quality to each of the plurality of profiles; and
transmitting the plurality of profiles from the transcoding device to the media device.

21. The transcoding device of claim 20, wherein the media device is configured to select one or more profiles based on the metadata.

22. The transcoding device of claim 20, wherein the media device is configured to receive said selected profiles from the transcoder device.
